(19) United States
(12) Patent Application Publication
(10) Pub. No.: US 2017/0236209 A1
(43) Pub. Date: Aug. 17, 2017

(54) Method and System for Collaboratively Managing Workflow

(71) Applicant: Huang & Associates Analytics Inc., Thornill (CA)

(72) Inventors: Zhigang Huang, Thornill (CA); Yoshihito Nathan Aiyama, Norcross, GA (US)

(21) Appl. No.: 15/044,896

(22) Filed: Feb. 16, 2016

(51) Int. Cl. G06Q 40/08; H04L 12/58; G06Q 10/10

(52) U.S. Cl. CPC G06Q 40/08; G06Q 10/103; H04L 51/046

(57) ABSTRACT

The present disclosure is generally directed to a method and system for collaboratively managing workflow. According to various implementations a first computing device (e.g., a server) displaying a first instance of a user interface on a second computing device (e.g., transmitting a web page with the user interface to a client). The user interface includes a plurality of tiles organized into a plurality of linear arrays (e.g., a plurality of rows or a plurality of columns). Each tile represents a project (e.g., a reinsurance program) and each linear array represents a stage of a process to be carried out for the project (e.g., a stage in a reinsurance process). Each tile is moveable on the user interface from at least one linear array of the plurality of linear arrays to at least one other linear array of the plurality of linear arrays.

### TECHNICAL FIELD

This disclosure relates generally to computer-based project management systems and, more particularly, to a method and system for collaboratively managing workflow.

### BACKGROUND

Organizations of all types—public and private, for-profit and non-profit—regularly take advantage of various forms of computer-based project management tools, such as Microsoft® Project. Many of these tools are web-based and require considerable training time to be used effectively.

One area in which effective project management is important is the insurance industry. For example, major insurance companies typically hedge or syndicate their risks of loss by aggregating many individual policies together and obtaining additional insurance protection on the aggregation in a transaction known as “reinsurance.” A typical reinsurance transaction involves multiple people, such as a broker, analysts, underwriters, modelers, protection buyers, and protection sellers. Not all of the individuals involved in such transactions are necessarily needed in every stage. Some individuals may work on a particular reinsurance contract until signing while others may only be involved, for example, in a post-signing audit.

### DRAWINGS

While the appended claims set forth the features of the present techniques with particularity, these techniques, together with their objects and advantages, may be best understood from the following detailed description taken in conjunction with the accompanying drawings of which:

FIG. 1A is an example of a computing system in which various embodiments may be implemented.

FIG. 1B is another example of a computing system in which various embodiments may be implemented.

FIG. 2 shows an implementation of a computing device according to an embodiment.

FIGS. 3A and 3B show a possible implementation of a user interface according to an embodiment.

FIG. 4 shows another possible implementation of a user interface according to an embodiment.

FIG. 5 shows a possible implementation of a messaging interface according to an embodiment.

FIG. 6 is a flowchart that shows actions carried out by a computing device in an embodiment.

FIG. 7 is a flowchart that shows actions carried out by a computing device in another embodiment.

### DESCRIPTION

The present disclosure is generally directed to a method and system for collaboratively managing workflow. According to various embodiments: The method involves a first computing device (e.g., computer hardware such as a server) displaying a first instance of a user interface on a second computing device (e.g., transmitting a web page with the user interface to a client device). The user interface includes a plurality of tiles organized into a plurality of linear arrays (e.g., a plurality of rows or a plurality of columns). Each tile represents a project (e.g., a reinsurance program) and each linear array represents a stage of a process to be carried out for the project (e.g., a stage in a reinsurance process). Each tile is moveable on the user interface from one linear array to another. The method further involves receiving, via the first instance of the user interface, a first user's interaction with the tile (e.g., receiving an indication of the first user “clicking” on the tile via the web page). In response to receiving the first user's interaction, the first computing device displays a first instance of a messaging interface on the second computing device (e.g., transmits the messaging interface to the client via web page or similar mechanism). The first computing device receives, via the first instance of the messaging interface, an entry of a first message associated with the project (e.g., receives the first message as entered by the first user from the client device via the web page). The method further includes (in various embodiments) displaying a second instance of the user interface on a third computing device (e.g., transmitting a web page with the user interface to another client device), receiving, via the second instance of the user interface, a second user's interaction with the tile (e.g., receiving an indication of the second user “clicking” on the tile via the web page). In response to receiving the second user's interaction, the first computing device displays a second instance of the messaging interface, including the first message, on the third computing device (e.g., transmits the messaging interface to the client device via web page or similar mechanism). The first computing device receives, via the second instance of the messaging interface, the second user's entry of a second message associated with the project (e.g., receives the second message as entered by the second user from the other client device via the web page).

In various embodiments: A method for collaboratively managing workflow involves a first computing device displaying a user interface on a second computing device, wherein the user interface includes a plurality of tiles organized into at least a first linear array and a second linear array (each tile representing a project and each linear array representing a stage in a process to be carried out on the project); annotating the tile with an identifier associated with an individual responsible for the project; and providing a visual effect for the identifier, wherein the visual effect indicates the workload of the individual.

This disclosure will sometimes refer to a computing device as a “server” or a “client” device. It is to be understood, however, that the various techniques described herein may also be implemented on devices that are in a peer-to-peer relationship. This disclosure also refers to various elements of a user interface being “clicked on” or subjected to a user's “click.” This term refers to a mouse, touchpad, or touchscreen interaction, but it is to be understood that any equivalent user interface interaction may also be used in any of the techniques described herein, as appropriate.

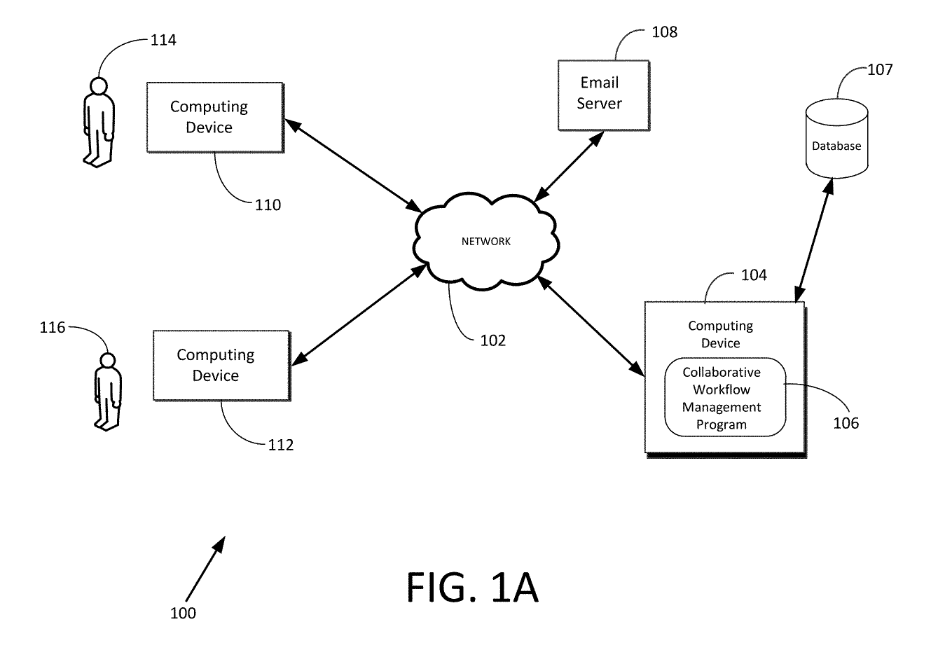

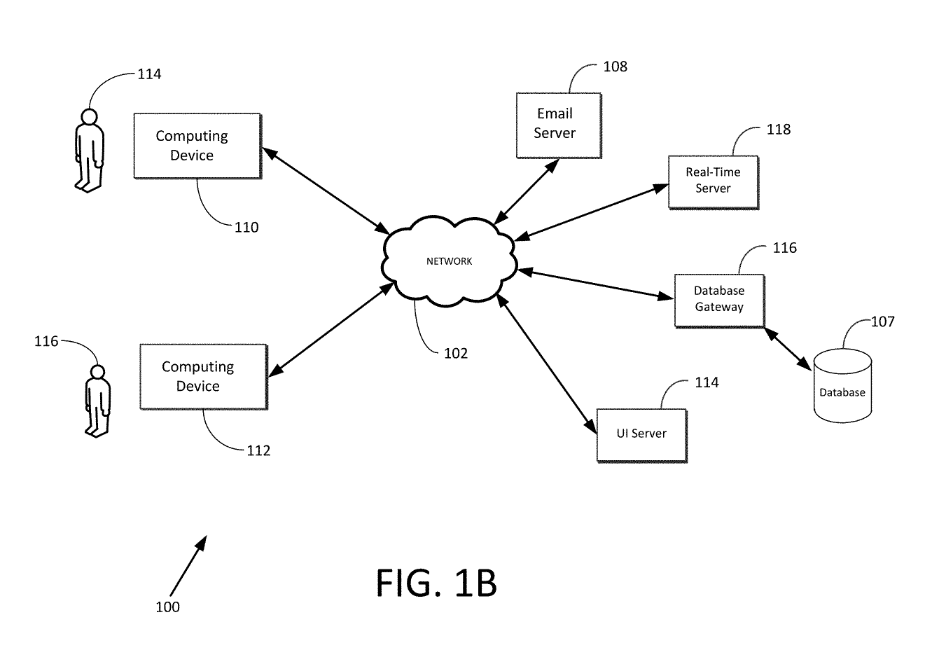

Various embodiments of the disclosure are implemented in the context of a computing system. Turning to FIG. 1A, an example of such computing system is shown. The computing system, generally labelled 100, includes a communication network (“network”) 102. Possible implementations of the network 102 include a local-area network, a wide-area network, a private network, a public network (e.g., the Internet), or any combination of these. The network 102 may include both wired and wireless components. A first computing device 104 is communicatively linked to the network 102. The first computing device 104 executes a collaborative workflow management program (“management program”) 106, which, in some embodiments, carries out one or more of the methods described herein. The first computing device 104 has access to a database 107. Also communicatively linked to the network 102 are: an email server 108, a second computing device 110, and a third computing device 112. For the sake of example, it is assumed that a first user 114 operates the second computing device 110 and a second user 116 operates the third computing device 112. The number of users and computing devices in FIG. 1A is only meant to be illustrative and any number is possible.

In an embodiment, the first computing device 104 interacts with the second computing device 110 and the third computing device 112 through various web-based interfaces (e.g., transmission of hypertext mark-up language (“HTML”) documents, which may include JavaScript code, from the first computing device 104 to the other computing devices) and Internet protocols (e.g., hypertext transport protocol (“HTTP”)). Thus, for example, when the first computing device 104 “displays” a user interface on one or more of the other computing devices in an embodiment, it does so by transmitting one or more web pages to the other computing devices. The computing device that receives the web page or pages renders the content on a display using, for example, a web browser.

Turning to FIG. 1B, another embodiment of the computing system 100 is shown. In this embodiment, the computing system 100 includes a user interface (“UI”) server 114, a database gateway 116, and a real-time server 118. The UI server 114 receives requests for UI content (e.g., web pages) from client devices (e.g., the second computing device 110 and the third computing device 112) and responds by delivering the UI content to the requesting devices. The database gateway 116 interacts with client devices (e.g., via a published application programming interface (“API”)) to permit and control access to content stored on the database 107. The real-time server 118 interacts with client devices to provide real-time updates triggered by actions of different users. In an embodiment, the real-time server 118 interacts with client devices using a real-time protocol, such as Server-Sent Events (“SSE”) via an HTTP connection with the client devices.

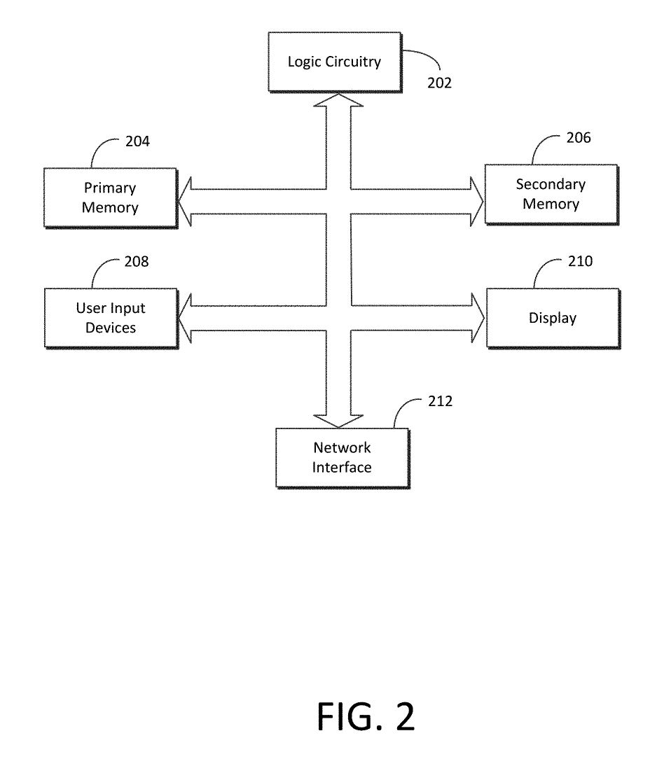

In one implementation, one or more of the computing devices of FIGS. 1A and 1B have the general architecture shown in FIG. 2. The device depicted in FIG. 2 includes logic circuitry 202 (e.g., one or more microprocessors, microcontrollers, application-specific integrated circuits, or field-programmable gate arrays), a primary memory 204 (e.g., volatile memory, random-access memory), a secondary memory 206 (e.g., non-volatile computer-readable media), user input devices 208 (e.g., a keyboard, mouse, or touchscreen), a display 210 (e.g., an organic, light-emitting diode display), and a network interface 212 (which may be wired or wireless). The memories 204 and 206 store instructions and data. The logic circuitry 202 executes the instructions and uses the data to carry out various procedures including, in some embodiments, the methods described herein.

The computing devices of FIGS. 1A and 1B (i.e., the logic circuitry 202 of each of the computing devices) are able to communicate with other devices of FIGS. 1A and 1B via the network interface 212 over the network 102. In an embodiment, this communication takes place via a user interface that the first computing device 104 or UI server 114 provides (or provides instructions for rendering) to other computing devices (such as the second computing device 110 and the third computing device 112). The specific nature of the user interface and what the user interface shows at any given time may vary depending what the user has chosen to view. Also, multiple users may interact with different instances of the user interface on different devices.

In an embodiment, the user interface includes a number of tiles, which are arranged into linear arrays. In an embodiment, each tile is generally rectangular in shape. Other shapes (e.g., square or oval) are possible, however. The linear arrays may be implemented as, for example, rows or columns. The user interface as a whole represents a process (e.g., an assembly line process or reinsurance process) and each tile represents a project that moves through multiple stages of the process. Each linear array represents one the stages of the process. According to an embodiment, one or more of the process stages is subdivided into statuses, and the user interface depicts each corresponding array as being subdivided accordingly.

According to an embodiment, each tile includes one or more of: the name of the project, the date the project was initiated, an urgency indicator, an identifier (e.g., initials) of the person responsible for the project from the beginning of the process to the end of the process (“project coordinator”), an identifier of the person who is responsible for one or more tasks involved at a particular stage of the process being carried out on the project (“stage coordinator”), and the name of the customer for whom the project is being performed. In an embodiment, one or both identifiers may include a visual indicator to indicate the workload of the individual represented by the identifier.

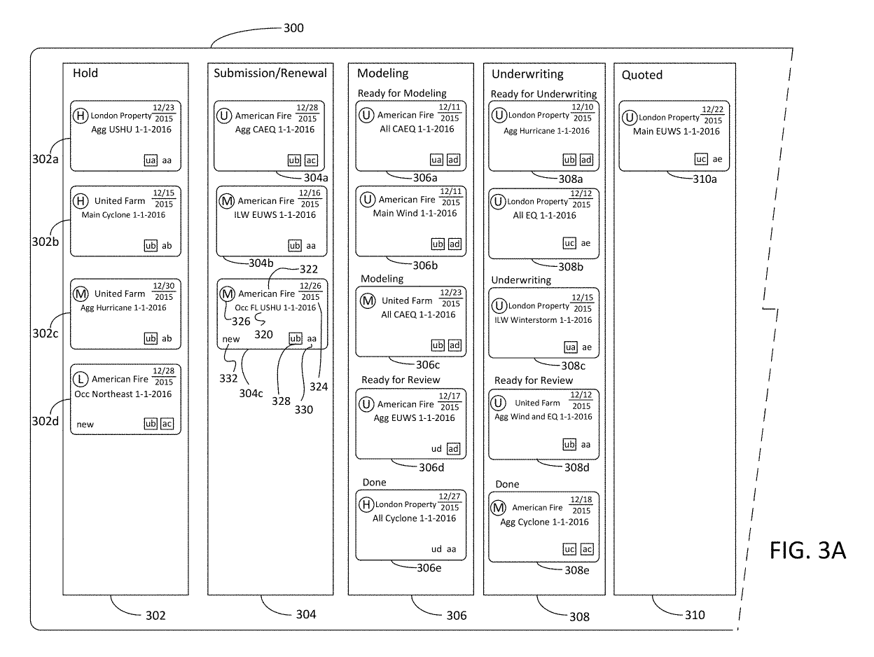

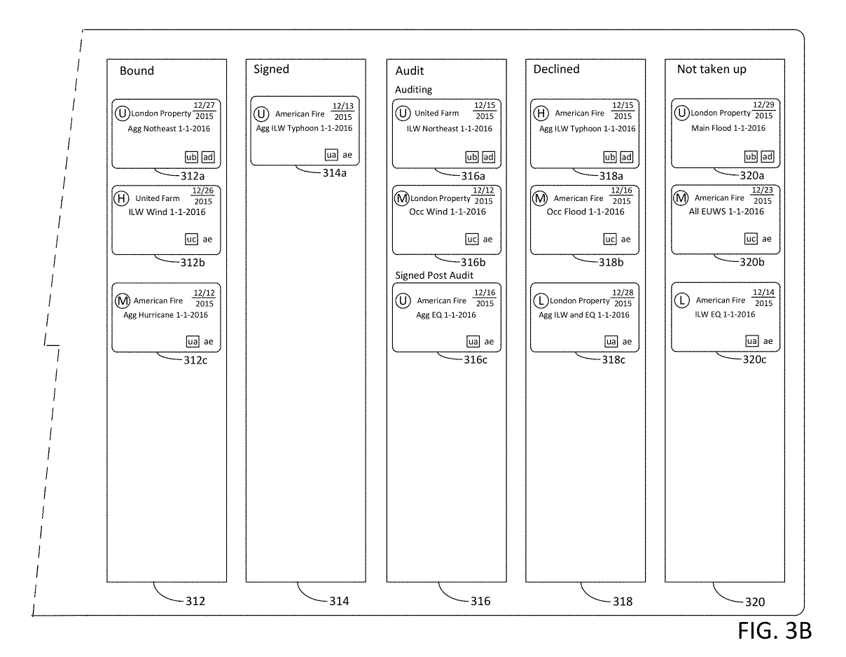

Turning to FIG. 3A and FIG. 3B, an example of a user interface according to an embodiment is shown. The user interface (“UI”), generally labeled 300, includes linear arrays 302, 304, 306, 308, 310, 312, 314, 316, 318, and 320. Each linear array represents a stage in a reinsurance process. For example, linear array 302 represents a hold stage, linear array 304 represents a submission/renewal stage, linear array 306 represents a modeling stage, linear array 308 represents an underwriting stage, linear array 310 represents a quoted stage, linear array 312 represents a bound stage, linear array 314 represents a signed stage, linear array 316 represents an audit stage, linear array 318 represents a declined stage, and linear array 320 represents a “not taken up” stage.

Each of the linear arrays depicted in FIG. 3A and FIG. 3B includes one or more tiles. Each tile in an array represents a project that is currently in the stage of the process associated with the array. Not every array will necessarily have tiles. For example, one or more of the arrays might contain a single tile, many tiles, or no tiles. Thus, the arrangement shown in FIG. 3A and FIG. 3B is meant only to be illustrative.

For example, linear array 302 includes tiles 302a, 302b, 302c, and 302d, each of which represents a project that is in the hold stage of the reinsurance process; linear array 304 includes tiles 304a, 304b, and 304c, each of which represents a project that is in the submission/renewal stage of the reinsurance process; linear array 306 includes tiles 306a, 306b, 306c, 306d, and 306e, each of which represents a project that is in the modeling stage of the reinsurance process; linear array 308 includes tiles 308a, 308b, 308c, 308d, and 308e, each of which represents a project that is in the underwriting stage of the reinsurance process; and linear array 310 includes tile 310a, which represents a project that is in the quoted stage of the reinsurance process.

Continuing with FIG. 3B, linear array 312 includes tiles 312a, 312b, and 312, each of which represents a project that in the bound stage of the reinsurance process (i.e., basically the reinsurance contract has been negotiated and finalized); linear array 314 includes tile 314a, representing a project that is in the signed stage of the reinsurance process; linear array 316 includes tiles 316a, 316b, and 316c, each of which represents a project that is in the audit stage of the reinsurance process; linear array 318 includes tiles 318a, 318b, and 318c, each of which represents a project that has been declined (i.e., no agreement was reached); and linear array 320 includes tiles 320a, 320b, and 320c, each of which represents a project that has not been taken up (e.g., the reinsurer chose not to offer the reinsurance).

In an embodiment, one or more of the linear arrays is subdivided into status categories, with each status category indicating the status of one or more projects within the stage represented by the linear array. For example, within the linear array 304 (which represents the modeling stage), there is a “Ready for Modeling” status, indicating that a reinsurance program is ready for modeling; a “Modeling” status, indicating that a reinsurance program is in the process of being modeled; a “Ready for Review” status, indicating that a reinsurance program has been modeled and is ready for review; and a “Done” status, indicating that a reinsurance program is done with the modeling stage and can be moved to the underwriting stage.

Using the tile 304c as an example, each of the tiles includes the title 320 of the project (the title of the reinsurance program or contract in this example), the name 322 of the customer (the name of the insurance company for whom reinsurance is being provided in this example), the date 324 that the project is due, an urgency level 326 (which is ‘M’ for medium, in this example), an identifier 328 of the person responsible for the project throughout the process (the underwriter responsible for the reinsurance program, in this example), and an identifier 330 of the person responsible for one or more tasks involved in the stage (the analyst responsible for this reinsurance program during the submission/renewal stage, in this example). In some cases, the tile may include a special designator 332, which in the example of tile 302b indicates that the reinsurance program is new (versus a renewal of a pre-existing program).

According to an embodiment, the urgency level 326 includes one or more visual indicators (e.g., an alphanumeric character and a color code) to indicate the urgency of the project at that particular stage. For example, L in inside a green circle could mean “Low,” M in a yellow circle could mean “Medium,” H in a red circle could mean “High,” and U in a purple circle could mean “Urgent.” The urgency levels may, for example, be automatically set according to how far out a due date is set (e.g., Low=a week or more, Medium=due within a week, High=due within two days, Urgent=past due). Furthermore, one or more of the identifiers 328 and 330 could include one or more visual indicators to indicate the workload of the individual represented by the identifier (e.g., no highlighting=normal workload, red box around indicator=heavy workload). For example, on the tile 304b there is a box around the identifier “ub,” which indicates that the underwriter has a heavy workload, but no box around the identifier “aa,” which indicates that the analyst has a normal workload.

In an embodiment, a user with sufficient privileges may (e.g., via an administrative user interface provided by the management program 106) customize: (a) which codes and colors to use for various priority levels and various workload levels, (b) the number of jobs that project coordinators and stage coordinators may have before they are considered to have heavy workloads, or (c) the length of time left until the deadline that corresponds to each urgency level.

In an embodiment, a user may interact with the UI (e.g., via mouse or keyboard) to move a tile from one linear array to another in order to indicate progress of the project represented by the tile from one stage of the process to another. When this occurs, the UI may depict the tile moving the tile from the source linear array, realign any remaining tiles in the source linear array to close the gap left by the tile being moved, open a gap in the destination linear array (e.g., according to an auto sort setting), and depict the tile being moved as filling the gap. For example, the first user 114 might interact with the UI 300 on the second computing device 110 (the UI 300 having been transmitted to the second computing device 110 via the network 102) to move the tile 304e from the linear array 304 to the linear array 306. UI 300 reacts by removing the tile 304e from the linear array 304 and inserting the tile within the area of the array 306 associated with the “Ready for Underwriting” status (e.g., below the tile 306a, if auto sort is set according to urgency). In an embodiment, a user with sufficient privileges may (e.g., via an administrative user interface provided by the management program 106) restrict how tiles can be moved between columns. For example, an administrator could restrict interaction with the UI 300 so that a tile could not be moved directly from submission/renewal (linear array 304) to underwriting (linear array 308) without first going through modeling (linear array 306). In response to the movement, the management program 106 may generate an electronic message (e.g., an email) for the individual responsible for the project at the destination stage.

In an embodiment, users may interact with the UI (e.g., via mouse or keyboard) to open a messaging interface that allows the composition of notes and the attachment of things such as files or links. In various embodiments, the notes and attachments may be associated with a specific project or may be of general interest. Furthermore, users may, in various embodiments, employ filters or carry out queries to that only those tiles representing projects of interest to the user are shown.

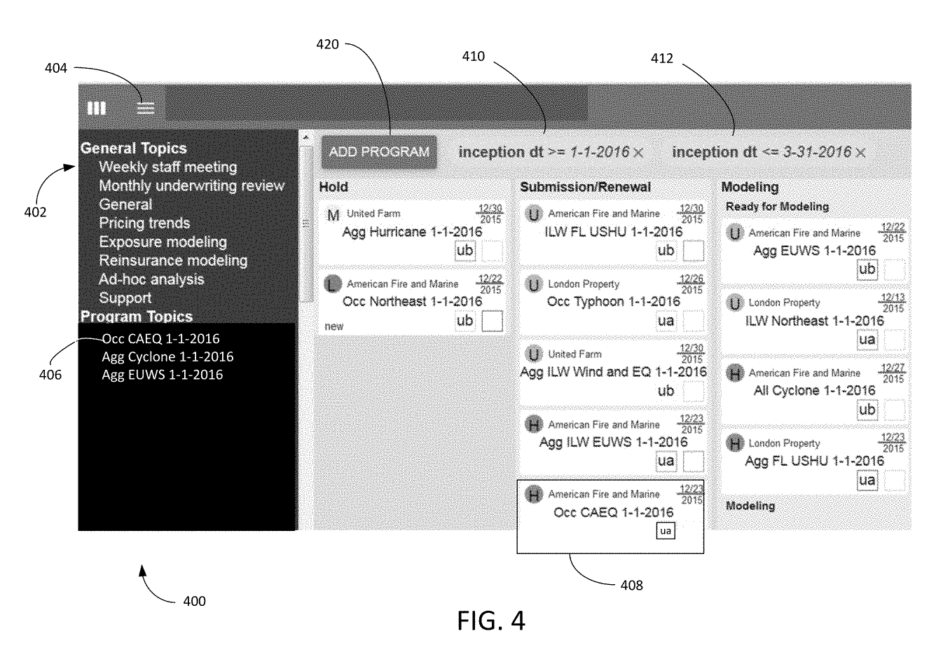

Turning to FIG. 4, a UI configured according to an embodiment is shown. The UI, generally labelled 400, includes linear arrays and tiles having the functionality described in conjunction with FIGS. 3A and 3B. The UI 400 further includes a list 402 of topics (which may be hidden or shown by, for example, clicking on a button 404). The list 402 includes general topics (which are not necessary connected to any particular project) and project-specific topics (which are referred to in this embodiment as “Program Topics,” since each “project” in this example is a reinsurance “program”). Each topic in the list 402 acts as a control or “button,” such that if a user interacts with a topic (e.g., clicks on it) the management program 106 responds by delivering a messaging interface. Users may then post messages and attach files relating to the selected topic. According to an embodiment, clicking on a tile has the same effect as clicking on a program topic. For example, clicking on the topic title 406 and clicking on the tile 408 would cause the management program 106 to deliver the same messaging interface.

The UI 400 also includes filter fields 410 and 412. According to an embodiment, a user may enter filter criteria in the filter fields 410 and 412, which get transmitted back to the first computing device 104. The first computing device 104 responds by limiting the display of the tiles to those which fit the filter criteria. In some embodiments, the UI 400 includes a search field instead of filter fields.

According to an embodiment, a user with sufficient privileges may request the creation of a new tile (i.e., define a new project) via the UI 400 by activating (e.g., clicking) the button 420. The UI 400 then displays an administrative interface in which the user can enter details about the project, including the user's selection of one or more individuals responsible for the project (e.g., a project coordinator and stage coordinator). Once the management program 106 receives this selection, the management program may access the database 107 to update a value or values associated with the selected individual or individuals' workload (e.g., increment the number of projects for that individual by one), compare the updated value with a preset threshold (or thresholds) for workload statuses (e.g., a threshold of six projects for an individual might be considered “heavy”), and change the visual effect of the identifier of the individual based on the comparison (e.g., if the number of projects exceeds six, the individual's initials on the tile have a red box around them). Examples of visual effects include a color background, a border shape, and a text color.

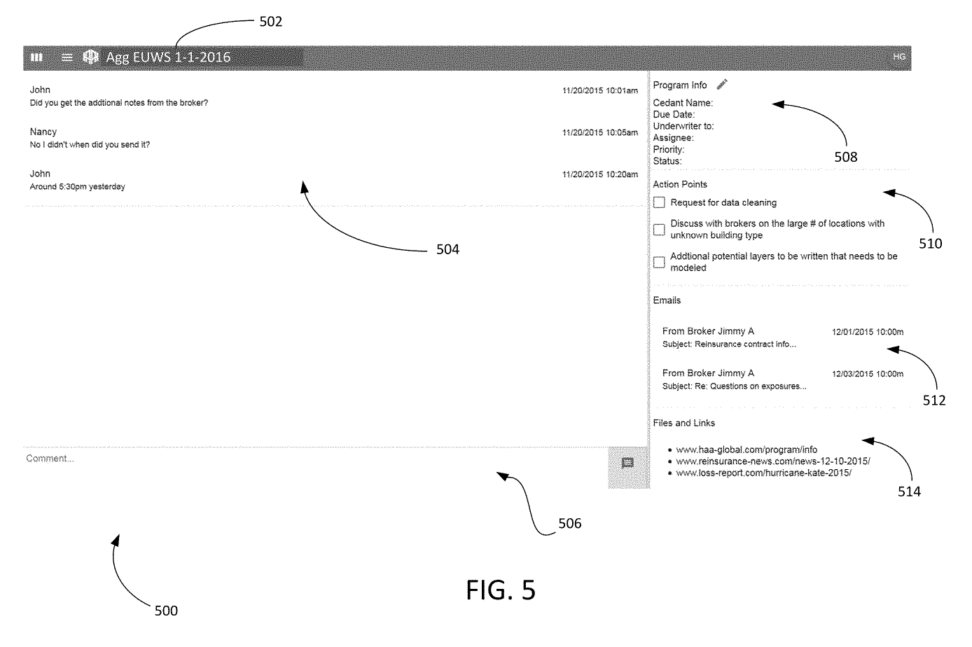

Turning to FIG. 5, an example of a messaging interface configured according to an embodiment is shown. The messaging interface, generally labeled 500, is associated with a particular topic whose title is listed in region 502. The messaging interface 500 includes a prior message display region 504, a message entry region 506, a project information region 508, an action points region 510, a related email region 512, and a files and links region 514. The prior message display region 504 includes the prior messages posted on the topic whose title is listed in region 502 (e.g., general topic or project specific topic). The message entry region 506 is configured to receive a text entry of a user. The project information region 508 displays information about the project (about the reinsurance program Agg EUWS 1-1-2016, in this example). The action points region 510 displays action points (e.g., a “to-do list”) that users with sufficient privileges can check off once actions are completed. The related emails region 512 displays a list of emails (which may also function as links to the emails) that are related to the topic. The files and links region 514 displays files (e.g., filenames that operate as links to the files) and links (e.g., uniform resource locators (“URLs”)) containing content relating to the topic.

In an embodiment, users within the system 100 may post messages via email. For example, the first user 114 might compose an email with the text “Agg EUWS 1-1-2016” in the subject line and transmit the email (via the email server 108) to the management program 106. The management program 106 identifies the subject line as being associated with the “Agg EUWS 1-1-2016” program and, accordingly, stores the text of the email (and, if applicable, any attachments) in the database 107 such that the message (and any attachment) becomes part of the thread associated with the Agg EUWS 1-1-2016 program. In the embodiment of FIG. 1B, the database gateway 116 could carry out the function of storing the email in the database 107, while the real-time server 118 could, for any users are presently viewing the message interface 500 associated with the Agg EUWS 1-1-2016 program, update the messaging interface 500 in real time to show the new message in the message display region 504.

To illustrate the functionality of the messaging interface, an example scenario will now be described. Assume that the first user 114 and the second user 116 are collaborating on the Agg EUWS 1-1-2016 program (represented by the tile 306d). The first user 114 operates the second computing device 110 to log in to the management program 106. The management program 106 transmits the UI 300 to the second computing device 112, which renders the UI 300 on its display. The first user 114 selects the tile 306d and interacts with the tile 306d (e.g., by clicking on it). The second computing device 112 responds (possibly after an exchange of messages with the management program 106) by displaying the messaging interface 500. The first user 114 enters the text “Did you get the additional notes from the broker?” The second computing device 110 transmits this text to the management program 106, which stores the message in the database 107 in association with the Agg EUWS 1-1-2016 program.

Continuing with the example scenario, the second user 116 operates the third computing device 112 to log in to the management program 106. The management program 106 transmits the UI 300 to the third computing device 112, which renders the UI 300 on its display. The second user 116 selects the tile 306d and interacts with the tile 306d (e.g., by double clicking on it). The management program 106 retrieves the first user's message from the database (along with any other messages associated with the Agg EUWS 1-1-2016 program and the first user's message to the third computing device 112. The third computing device 112 responds (possibly after an exchange of messages with the management program 106) by displaying the messaging interface, which will include the message from the first user 114. The second user 114 enters the text “No I didn't when did you send it?” The third computing device 112 transmits this text to the management program 106, which stores the message in a database in association with the Agg EUWS 1-1-2016 program. The first user 114 could respond in the same manner, other users with sufficient access privileges could add to the message thread, and so on. In a variation on this scenario, if the first and second users are logged in at the same time (e.g., on the UI server 114), the real-time server 118 could update the messaging interface instances on each of the first and second computing devices in real time while, in parallel, the database gateway 116 updates the database 107.

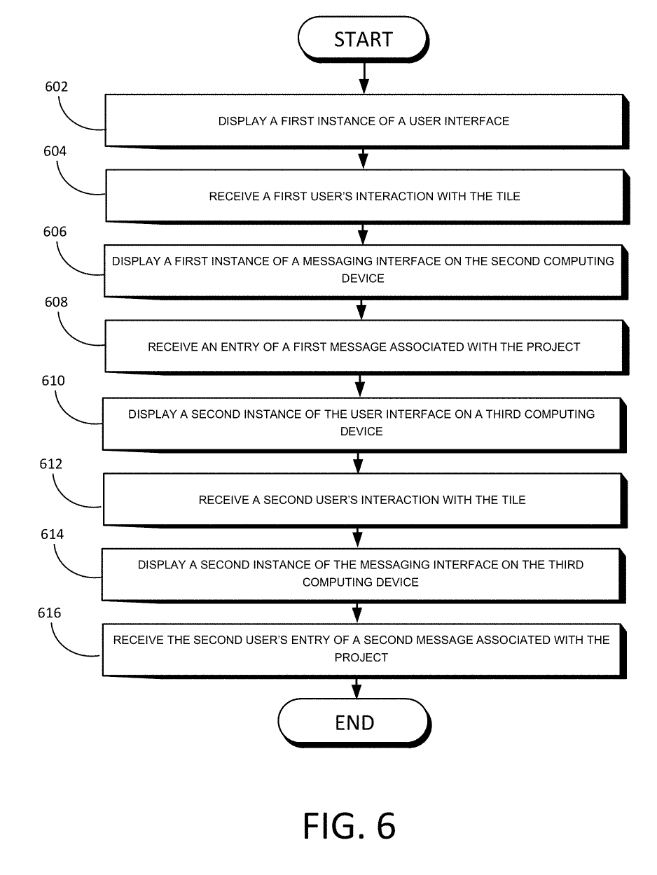

Turning to FIG. 6, an example of actions taken by a computing device (such as the first computing device 104) in an embodiment will now be described. At block 602, the computing device displays a first instance of a user interface (such as the UI 300) on the second computing device 110 (e.g., transmits a web page that includes the UI 300 to the second computing device 110). At block 604, the computing device receives, via the first instance of the user interface, the first user 114's interaction with a tile (e.g., the first user 114 clicking on the tile 306d). At block 606, in response to receiving the first user 114's interaction, the computing device displays a first instance of a messaging interface on the second computing device 110 (e.g., transmits a web page that includes the messaging interface 500 to the second computing device 110). At block 608, the computing device receives, via the first instance of the messaging interface, an entry of a first message associated with the project (e.g., an entry of a message relating to the Agg EUWS 1-1-2016 reinsurance program). At block 610, the computing device displays a second instance of the user interface on the third computing device 112 (e.g., transmits a web page that includes the UI 300 to the third computing device 112). At block 612, the computing device receives, via the second instance of the user interface, the second user 116's interaction with the tile (e.g., the second user 116 clicking on the tile 306d). In response to receiving the second user 116's interaction, at block 614 the computing device displays a second instance of the messaging interface on the third computing device, including the first message (e.g., transmits a web page that includes the messaging interface 500 to the second computing device 110). At block 616, the computing device receives, via the second instance of the messaging interface, the second user 116's entry of a second message associated with the project.

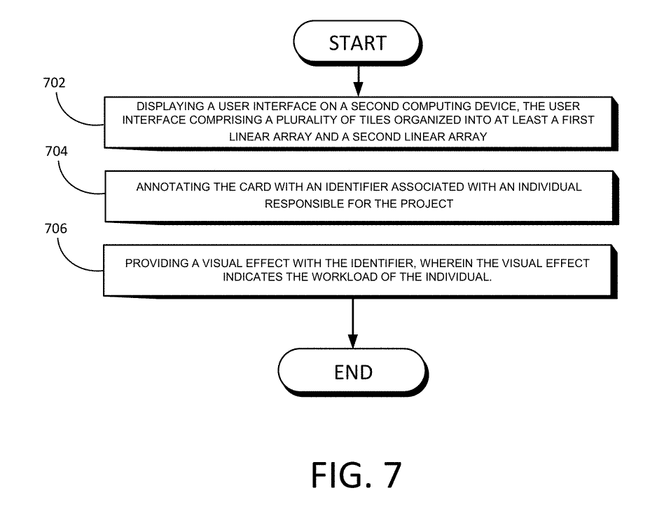

Turning to FIG. 7, an example of actions taken by a computing device (such as the first computing device 104) in an embodiment will now be described. At block 702, the computing device displays a user interface on a second computing device 110 (e.g., transmits a web page that includes the UI 300 to the second computing device 110). As part of the process of displaying the user interface, at block 704, the computing device annotates the tile with an identifier associated with an individual responsible for the project. Also as part of the process of displaying the user interface, at block 706, the computing device provides a visual effect with the identifier, wherein the visual effect indicates the workload of the individual.

It should be understood that the embodiments described herein should be considered in a descriptive sense only and not for purposes of limitation. Descriptions of features or aspects within each embodiment should typically be considered as available for other similar features or aspects in other embodiments. It will be understood by those of ordinary skill in the art that various changes in form and details may be made therein without departing from their spirit and scope as set forth in the following claims.

What is claimed is:

1. A method, on a first computing device, for collaboratively managing workflow, the method comprising:
displaying a first instance of a user interface on a second computing device, the user interface comprising a plurality of tiles organized into a plurality of linear arrays, wherein
each tile represents a project and each linear array represents a stage of a process to be carried out for the project;
each tile is moveable on the user interface from at least one linear array of the plurality of linear arrays to at least one other linear array of the plurality of linear arrays;
receiving, via the first instance of the user interface, a first user's interaction with the tile;
in response to receiving the first user's interaction, displaying a first instance of a messaging interface on the second computing device;
receiving, via the first instance of the messaging interface, an entry of a first message associated with the project;
displaying a second instance of the user interface on a third computing device;
receiving, via the second instance of the user interface, a second user's interaction with the tile;
in response to receiving the second user's interaction, displaying a second instance of the messaging interface on the third computing device, wherein the second instance of the messaging interface includes the first message; and
receiving, via the second instance of the messaging interface, the second user's entry of a second message associated with the project.

2. The method of claim 1, further comprising storing the first message and the second message in a database such that the first message and the second message are associated with the project within the database.

3. The method of claim 2, further comprising:
receiving an email that includes a third message;
determining, based on the subject of the email, that the message is to be associated with the project represented by the tile; and
storing the third message in the database such that the third message is associated with the project within the database.

4. The method of claim 1, further comprising pushing the first message out to the second instance of the messaging interface without a request from the third computing device.

5. The method of claim 1, further comprising:
detecting that, within the first instance of the user interface, the tile has been moved from a first linear array of the plurality of linear arrays to a second linear array of the plurality of linear arrays;
in response to the detecting, updating, the second instance of the first user interface to show the tile moved from the first linear array to the second linear array.

6. The method of claim 1, further comprising:
detecting that, within the first instance of the user interface, the tile has been moved from a first linear array of the plurality of linear arrays to a second linear array of the plurality of linear arrays;
in response to the detecting, transmitting an electronic message to the second user indicating that the project is in the stage represented by the second linear array.

7. The method of claim 1, further comprising:
detecting that, within the first instance of the user interface, the tile has been moved from a first linear array of the plurality of linear arrays to a second linear array of the plurality of linear arrays;
in response to the detecting, updating the first instance of the user interface to create an opening in the second linear array in order to accommodate the tile according to an auto sort function.

8. The method of claim 1, further comprising:
displaying, in the first instance of the user interface, a list of topics, including a general topic that is not specific to a project represented by a tile on the user interface;
receiving, via the first instance of the user interface, the first user's selection of the general topic;
in response to receiving the first user's selection of the topic, displaying a first instance of a messaging interface associated with the general topic on the second computing device;
receiving, via the first instance of a messaging interface associated with the general topic, the first user's entry of a first message associated with the general topic;
receiving, via the second instance of the user interface, a second user's selection of the general topic;
in response to receiving the second user's selection, displaying a second instance of the messaging interface associated with the general topic, including the first message associated with the general topic, on the third computing device; and
receiving, via the second instance of the messaging interface associated with the general topic, the second user's entry of a second message associated with the general topic.

9. The method of claim 1, further comprising:
receiving, in the first instance of the user interface, a filtering parameter; and
displaying, on the first instance of the user interface, only those tiles of the plurality of tiles that are consistent with the filtering parameter.

10. The method of claim 1, further comprising:
displaying, in the first instance of the messaging interface, information regarding the project represented by the tile.

11. The method of claim 1, wherein the tile represents a reinsurance program.

12. The method of claim 1, wherein each of the plurality of linear arrays represents a stage in a reinsurance process.

13. A method, on a first computing device, for collaboratively managing workflow, the method comprising:
displaying a user interface on a second computing device, the user interface comprising a plurality of tiles organized into at least a first linear array and a second linear array,
wherein each tile represents a project,
wherein the first linear array represents a first stage of a process to be carried out for the project and the second linear array represents a second stage of a process to be carried out for the project;
annotating the tile with an identifier associated with an individual responsible for the project; and
providing a visual effect for the identifier, wherein the visual effect indicates the workload of the individual.

14. The method of claim 13, further comprising:
receiving a user request to create the tile, including a selection of the individual responsible for the project; and
accessing a database to update a value associated with the workload of the individual.

15. The method of claim 14, further comprising:
comparing the updated value with a preset threshold; and
changing the visual effect based on the comparison.

16. The method of claim 13, wherein the visual effect is selected from a group consisting of a color background, a border shape, and a text color.

17. A system for collaboratively managing workflow, the system comprising:
a first computing device that
displays a first instance of a user interface on a second computing device, the user interface comprising a plurality of tiles organized into a plurality of linear arrays, wherein
each tile represents a project and each linear array represents a stage of a process to be carried out for the project;
each tile is moveable on the user interface from at least one linear array of the plurality of linear arrays to at least one other linear array of the plurality of linear arrays;
receives, via the first instance of the user interface, a first user's interaction with the tile;
in response to receiving the first user's interaction, displays a first instance of a messaging interface on the second computing device;
receives, via the first instance of the messaging interface, an entry of a first message associated with the project;
displays a second instance of the user interface on a third computing device;
receives, via the second instance of the user interface, a second user's interaction with the tile;
in response to receiving the second user's interaction, displays a second instance of the messaging interface on the third computing device, wherein the second instance of the messaging interface includes the first message; and
receives, via the second instance of the messaging interface, the second user's entry of a second message associated with the project.

18. The system of claim 17, further comprising a database gateway that stores the first message and the second message in a database such that the first message and the second message are associated with the project within the database.

19. The system of claim 18,
wherein the first computing device
receives an email that includes a third message;
determines, based on the subject of the email, that the message is to be associated with the project represented by the tile; and
the database gateway stores the third message in the database such that the third message is associated with the project within the database.

20. The system of claim 17, further comprising a real-time server that pushes the first message out to the second instance of the messaging interface without a request from the third computing device.
